(19) United States
(12) Patent Application Publication
(10) Pub. No.: US 2026/0178389 A1
(43) Pub. Date: Jun. 25, 2026

(54) SYSTEMS AND METHODS FOR PROVIDING CUSTOMIZABLE CLOUD APPLICATION FUNCTIONS

(71) Applicants: Dmitry Shapiro, Spring Valley, CA (US); Sean Edward Thielen, New York, NY (US)

(72) Inventors: Dmitry Shapiro, Spring Valley, CA (US); Sean Edward Thielen, New York, NY (US)

(21) Appl. No.: 18/989,961

(22) Filed: Dec. 20, 2024

(51) Int. Cl. G06F 9/50

(52) U.S. Cl. CPC G06F 9/5027

(57) ABSTRACT

Systems and methods for providing customizable cloud application functions. Exemplary implementations may: stores function definitions of cloud application functions identifying lists of resources implemented to provide the cloud application functions and including instructions that facilitate the implementation of the cloud application functions by the resources; obtain calls generated by applications for execution of specified ones of the cloud application functions, the calls including function-level prompts which facilitate implementation of the resources to provide the cloud application functions; execute the function-level prompts to provide the cloud application functions in response to the calls; update the applications in response to execution of the cloud application functions specified by the individual calls; and/or other exemplary implementations.

### FIELD OF THE DISCLOSURE

The present disclosure relates to cloud application functions, more particularly to customizable cloud application functions that implement machine-learning models.

### BACKGROUND

Machine-learning model agents for performing various tasks and operations are known. No-code application builders are known.

### SUMMARY

Machine learning models can be employed to perform and optimize a wide range of tasks. One approach to leveraging the capabilities of machine learning is by integrating machine-learning models into various applications and environments through machine-learning agents. These agents can be utilized across diverse applications, eliminating the need for developers to rewrite code for identical functions performed by these agents in different contexts. The present disclosure provides methods for enabling developers to create customized machine-learning agents using a no-code builder, facilitating their deployment across a variety of use cases.

One or more aspects of the present disclosure include a system for providing customizable cloud application functions that implement machine-learning models to execute actions and/or providing a user interface that facilitates development of customizable cloud application functions. The system may include electronic storage, one or more hardware processors configured by machine-readable instructions, and/or other components. Executing the machine-readable instructions may cause the one or more hardware processors to facilitate providing customizable cloud application functions that implement machine-learning models to execute actions and/or providing a user interface that facilitates development of customizable cloud application functions. The machine-readable instructions may include one or more computer program components. The one or more computer program components may include one or more of a call component, an execution component, a user interface component, an input component, a function component, and/or other components.

The electronic storage may store function definitions of cloud application functions. The function definitions may identify lists of resources implemented to provide the cloud application functions. The function definitions may include instructions that facilitate the implementation of the cloud application functions by the resources. The resources may include one or more machine-learning models and/or other resources. By way of non-limiting illustration, the function definitions may include a first function definition of a first cloud application function and/or other function definitions. The first function definition may identify a first machine-learning model. The function definition may include instructions dictating how the first machine-learning model is implemented to provide the first cloud application function.

The call component may be configured to obtain calls generated by applications for execution of specified ones of the cloud application functions. The individual calls may specify one or more of the cloud applications functions to be executed. The individual calls may include one or more of function-level prompts, application information, and/or other information. The function-level prompts may facilitate implementation of the resources to provide the cloud application functions specified. The application information may be relevant to the function-level prompts. By way of non-limiting illustration, the calls may include a first call generated by a first application. The first call may specify the first application function. The first call may include a first function-level prompt that facilitates the implementation of the first machine-learning model to provide the first application function. The first call may include first application information relevant to the first function-level prompt and/or other information.

The execution component may be configured to execute the function-level prompts to provide the cloud application functions in response to the calls. Executing the function-level prompts may include configuring resource-level prompts in accordance with the application information for the resources identified by the function definitions of the cloud application functions to be provided. Executing the function-level prompts may further include prompting the resources with the resource-levels prompts to provide the cloud application functions. By way of non-limiting illustration, the first function-level prompt may be executed to provide the first cloud application function in response to the first call. Executing the first function-level prompt may include configuring a first resource-level prompt for the first machine-learning model in accordance with the first application information. Executing the first function-level prompt may further include prompting the first machine-learning model with the first resource-level prompt to execute the first cloud application function.

The execution component may be configured to update the applications in response to execution of the cloud application functions specified by the individual calls. By way of non-limiting illustration, the first application may be updated in response to execution of the first cloud application function.

The user interface component may be configured to effectuate presentation of an application function development interface to developers through client computing platforms associated with the developers. The application function development interface may facilitate selection of values of application function parameters by the developers. The application function parameters may include one or more resource parameters, one or more instruction parameters, and/or other types of parameters. The one or more resource parameters may include at least a model parameter and/or other types of resource parameters. By way of non-limiting illustration, presentation of the application function development interface may be effectuated through a first client computing platform associated with a first developer.

The input component may be configured to receive, from the client computing platforms, input information and/or other information. The input information may indicate the values of application function parameters by the developers via the application function development interface. By way of non-limiting illustration, first input information may be received from the first client computing platform. The first input information may include one or more values of the one or more instruction parameters, one or more values of the one or more resource parameters, and/or other values. The one or more values of the one or more resource parameters may include at least a first value of the model parameter specifying a first machine-learning model.

The function component may be configured to, responsive to the receipt of the input information, configure function definitions of cloud application functions in accordance with the input information. By way of non-limiting illustration, the function definitions may include a first function definition of a first cloud application function configured in accordance with first input information. The first function definition may identify lists of resources implemented to provide the first cloud application function. The resources may be specified by the one or more values of the one or more resource parameters. The resources may include the first machine-learning model. The first function definition may include instructions dictating how the first machine-learning model is implemented to provide the first cloud application function. The instructions may be specified by the one or more values of the one or more instructions parameters.

The function component may be configured to provide the function definitions of the cloud application functions to the developers. The cloud application functions may be executed responsive to calls generated by applications specifying the cloud application functions. By way of non-limiting illustration, the first function definition of the first cloud application function may be provided such that the first cloud application function is executed responsive to a call generated by an application specifying the first cloud application function.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

These and other features, and characteristics of the present technology, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system for providing customizable cloud application functions and providing a user interface that facilitates development of customizable cloud application functions, in accordance with one or more implementations.

FIG. 2 illustrates a method for providing customizable cloud application functions, in accordance with one or more implementations.

FIG. 3 illustrates a method for providing a user interface that facilitates development of customizable cloud application functions, in accordance with one or more implementations.

FIG. 4 illustrates an exemplary user interface, in accordance with one or more implementations.

### DETAILED DESCRIPTION

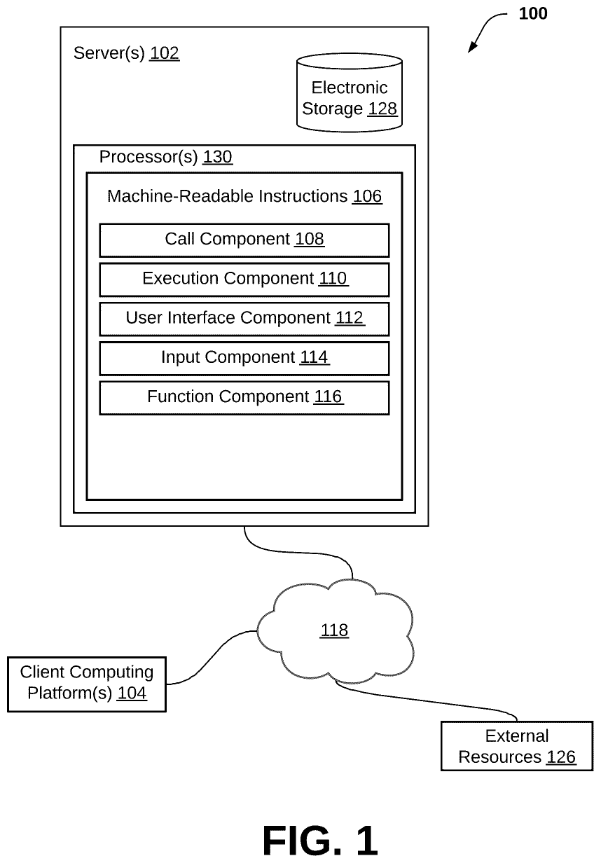

FIG. 1 illustrates a system 100 configured for providing customizable application functions and/or providing a user interface that facilitates development of customizable cloud application functions, in accordance with one or more implementations. In some implementations, system 100 may include one or more server(s) 102, electronic storage 128, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Executing the machine-readable instructions 106 may cause server(s) 102 to facilitate providing customizable application functions and/or providing a user interface that facilitates development of customizable cloud application functions. Machine-readable instructions 106 may include one or more instruction components. The instruction components may include computer program components. The instruction components may include one or more of call component 108, execution component 110, user interface component 112, input component 114, function component 116, and/or other instruction components.

Electronic storage 128 may store function definitions of cloud application functions. The function definitions may identify lists of resources implemented to provide the cloud application functions. The resources may include information sets, information sources, visualization tools, algorithms and/or functions, and/or other resources. In some implementations, the resources may be included in external resources 126 or stored in electronic storage 128. The resources may include one or more machine-learning models and/or other resources. The one or more machine learning-models may be stored in electronic storage 128, obtained from external resources 126, and/or obtained from other sources. By way of non-limiting illustration, the function definitions may include a first function definition of a first cloud application function and/or other function definitions. The first function definition may identify a first machine-learning model. The function definition may include instructions dictating how the first machine-learning model is implemented to provide the first cloud application function.

The one or more machine-learning models may be trained machine-learning models. The trained machine learning models may be trained using training information. In some implementations, the machine-learning model may utilize one or more of a transformer model, artificial neural network, naïve Bayes classifier algorithm, k-means clustering algorithm, support vector machine algorithm, linear regression, logistic regression, decision trees, random forest, nearest neighbors, and/or other approaches. System 100 may utilize training techniques such as deep learning, supervised learning, reinforcement learning, and/or other techniques.

In supervised learning, the model may be provided with a known training dataset that includes desired inputs and outputs, and the model may be configured to find a method to determine how to arrive at those outputs based on the inputs. The model may identify patterns in information, learn from observations, and/or make predictions. The model may make predictions and may be corrected by an operator—this process may continue until the model achieves a desired level of accuracy/performance. Supervised learning may utilize approaches including one or more of classification, regression, forecasting, and/or other approaches.

Semi-supervised learning may be similar to supervised learning, but instead uses both labelled and unlabeled data. Labelled data may comprise information that has meaningful tags so that the model can understand the data, while unlabeled data may lack that information. By using this combination, the machine-learning model may learn to label unlabeled data.

For unsupervised learning, the machine-learning model may study information to identify patterns. There may be no answer key or human operator to provide instruction. Instead, the model may determine the correlations and relationships by analyzing available information. In an unsupervised learning process, the machine-learning model may be left to interpret large information sets and address that information accordingly. The model may try to organize that information in some way to describe its structure. This might mean grouping the information into clusters or arranging it in a way that looks more organized. Unsupervised learning may use techniques such as clustering and/or dimension reduction.

Reinforcement learning may focus on regimented learning processes, where the machine-learning model may be provided with a set of actions, parameters, and/or end values (e.g., the desired outputs). By defining the rules, the machine-learning model then tries to explore different options and possibilities, monitoring and evaluating each result to determine which one is optimal to generate correspondences. Reinforcement learning teaches the model trial and error. The model may learn from past experiences and adapt its approach in response to the situation to achieve the best possible result.

In some implementations, the function definitions may identify multiple machine-learning models implemented to provide an individual cloud application function. The multiple machine-learning models may function cooperatively to provide the cloud application functions. Individual ones of the multiple machine-learning models may perform separate and distinct tasks. The tasks performed by the individual ones of the multiple machine-learning models may be determined by one or more prompts provided to the individual ones of the multiple machine-learning models. The tasks performed by the individual ones of the machine-learning models may be determined by a type of model of the individual ones of the multiple machine-learning models. In some implementations, the multiple models may be arranged in a particular order to provide the individual cloud application. By way of non-limiting illustration, the particular order may specify a first machine-learning model followed by a second machine-learning model and/or other machine-learning models. Outputs generated by the first machine learning model may be provided as inputs to the second machine-learning model. In some implementations, the instructions included in the function definition of the individual cloud application may include the particular order of machine-learning models.

The function definitions may include instructions that facilitate the implementation of the cloud application functions by the resources. The instructions included function definitions may dictate how to configure the resource-level prompts for the resources identified by the function definitions. The resource-level prompts may include prompts for one or more machine learning models identified by the function definitions. In some implementations, the instructions may specify one or more prompt formats for specific machine-learning models. A prompt format may include one or more fields for providing context, parameters, variables, and/or other information for the machine-learning model. The machine-learning model may utilize the context, parameters, variables, and/or other information in generating outputs. In machine-learning, “context” may refer to information that is provided as additional input that helps a model to understand meaning and/or relevance of a given input, question, and/or prompt. Context may include one or more of previous interactions, specific topics or subjects, relevant details or facts, situational information (e.g., tone, intent, and/or nuances), and/or other information. The prompt format may be configured such that prompting the machine-learning model using prompts generated by the prompt format results in a specific and desired output.

In some implementations, the prompt format may be associated with a specific purpose and/or action to be executed by the cloud application function. By way of non-limiting illustration, a cloud application function may be configured to identify obscenities within text. Instructions included in a function definition of the cloud application function may include a prompt format including a first field for identifying, including, and/or otherwise indicating a body of text. A first prompt generated based on the prompt format may indicate a first body of text. Prompting a machine-learning model with the first prompt may configure the machine learning model to identify obscenities within the first body of text. It will be appreciated that the exemplary prompt format and/or purpose described herein is not intended to be limiting, other prompt formats associated with other purposes, actions, and/or aims are envisioned.

In some implementations, instructions included in the function definitions may specify input requirements for the one or more machine learning models identified as resources. Input requirements may specify a type, format, size, and/or other features of inputs provided to the one or more machine-learning models. By way of non-limiting illustration, input requirements may specify a file type for inputs provided to a machine-learning model.

Call component 108 may be configured to obtain calls generated by applications for execution of specified ones of the cloud application functions. The individual calls may specify one or more of the cloud applications functions to be executed. By way of non-limiting illustration, the calls may include a first call generated by a first application. The first call may specify the first application function. The first call may include a first function-level prompt that facilitates the implementation of the first machine-learning model to provide the first application function. The first call may include first application information relevant to the first function-level prompt and/or other information.

In some implementations, the calls may be generated automatically, responsive to execution of the applications. The calls may be requests, by the applications, to execute the specified ones of the cloud application functions. The individual calls may include one or more of function-level prompts, application information, and/or other information. The function-level prompts may facilitate implementation of the resources to provide the cloud application functions specified. By way of non-limiting illustration, executing the function-level prompts may configure the resources identified by the function definitions of the specified cloud application functions. Configuring the resources identified by the function definitions may include fine-tuning one or more machine-learning models identified by the function definitions of the cloud application function for the individual application that generated the call to provide the cloud application function. Methods of fine-turning the one or more machine-learning models may vary based on the application that generated the call to provide the cloud application function. The method of fine-tuning the one or more machine learning models may include supervised fine-tuning, unsupervised fine-turning, and/or other methods. The methods of fine-tuning of the one or more machine learning models may be similar to and/or the same as methods for training the one or more machine learning models using training information.

Fine-tuning the one or more machine-learning models may include training the one or more models with a tuning dataset. In some implementations, the tuning dataset may be specific to the application that generated the call to provide the cloud application function and/or the cloud application function specified by the call. The application information included in the generated call may include the tuning dataset. The tuning dataset may be obtained from external resources 126 and/or otherwise obtained. Training and/or fine-tuning the one or more models using the tuning datasets may result in one or more enhanced models. The enhanced models may be capable of performing more specialized tasks and/or generate enhanced outputs. The enhanced outputs may be characterized by a higher level of sophistication, nuance, coherence, and/or other features.

In some implementations, the application information relevant to the function-level prompts may include the tuning datasets. The application information may be generated based on one or more of the application that generated the call, a runtime instance of the application, and/or other information. The application information may be identified by one or more parameters of the call generated by the application for passing values and/or information to the cloud function applications. In some implementations, specifications for the application may include instructions dictating how to configure the function-level prompts to facilitate the implementation of the resources to provide the cloud application functions. Specifications for the application may include source code for the application.

Execution component 110 may be configured to execute the function-level prompts to provide the cloud application functions in response to the calls. Executing the function-level prompts may include configuring resource-level prompts in accordance with the application information for the resources identified by the function definitions of the cloud application functions to be provided. The function definitions and/or the function-level prompts included in the calls generated by the applications may dictate how to configure the resource level prompts. Executing the function-level prompts may further include prompting the resources with the resource-levels prompts to provide the cloud application functions. Prompting the resources may include prompting the one or more models identified by the function definition with the resource level prompts. Prompting the model may include accessing the one or more models through a distributed network of models. Accessing a model may refer to a process of interacting with a model and/or utilizing a model's capabilities remotely through a network connection. There are several ways to access model(s) in a distributed network, including one or more of API calls (e.g., send requests to a server hosting a model, and receive responses through APIs), Remote Procedure Calls (RPC) (e.g., invoking model methods or functions remotely, as if the model were a local application), Message Passing (e.g., send messages to a server hosting a model, and receive responses through message queues or brokers), and/or other methods for providing prompts, receiving inferences, and/or otherwise communicating with one or more models

Distributed networks of models may refer to a design where multiple models are trained and/or deployed across a network of devices, or “nodes,” working together to achieve a common goal. Distributed networks provide many advantages. These include, among other, scalability to handle larger datasets and more complex models by distributing the computational workload, flexibility by allowing for the integration of different models and architectures, ability to continue functioning even if some nodes fail, leveraging diverse sets of information and models to enhance overall performance and/or generalization, reducing the risk of a single point of failure, and/or speeding up training times by parallelizing computations across nodes. Some examples of distributed networks include PyTorch Distributed, TensorFlow Distributed, Apache MXNet, and Hugging Face Transformers.

By way of non-limiting illustration, the first function-level prompt may be executed to provide the first cloud application function in response to the first call. Executing the first function-level prompt may include configuring a first resource-level prompt for the first machine-learning model in accordance with the first application information. Executing the first function-level prompt may further include prompting the first machine-learning model with the first resource-level prompt to execute the first cloud application function. In some implementations, prompting the first machine-learning model with the first resource-level prompt may include providing the first application information as input to the first machine-learning model and/or obtaining outputs generated by the first machine-learning model based on the provided inputs.

In some implementations, execute the function-level prompts to provide the cloud application functions in response to the calls may further include performing one or more operations in accordance with the function definitions of the cloud application functions. The one or more operations may be performed on and/or using the outputs generated by the one or more machine learning models and/or other information. By way of non-limiting illustration, the one or more operations may be performed to format, modify, and/or otherwise configure the outputs generated by the one or more machine learning models and/or other information.

Execution component 110 may be configured to update the applications in response to execution of the cloud application functions specified by the individual calls. Updating the applications may include providing the outputs of the one or more machine learning models and/or results of the one or more operations to the applications. The outputs and/or results may be provided as outputs to the calls generated by the applications. By way of non-limiting illustration, the first application may be updated in response to execution of the first cloud application function. Updating the first application may include providing the outputs generated by the first machine-learning model based on the first application information for use within the first application.

User Interface component 112 may be configured to effectuate the presentation of an application function development interface to developers through client computing platforms associated with the developers. By way of non-limiting illustration, the presentation of the application function development interface may be effectuated through a first client computing platform associated with a first developer. The application function development interface may facilitate selection of values of application function parameters by the developers. The application function development interface may include one or more user interface elements for selecting values of application function parameters. The user interface elements may facilitate development of the cloud application functions without requiring the developer to possess knowledge of or write source code for the cloud application functions. By way of non-limiting illustration user interface elements may include one or more of buttons, sliders, drop-down menus, text fields, toggle switches, and/or other types of user interface elements. Individual ones of the user interface elements may correspond with individual application function parameters and/or may facilitate section of values for the corresponding function parameters. In some implementations, the application function development interface may display the user interface elements with default values of the corresponding application function parameters. The application function development interface may include one or more notifications, flags, indicators, and/or other elements prompting the developer to modify the values of the application function parameters via user input indicating interaction with the corresponding user interface elements.

The application function parameters may include one or more resource parameters, one or more instruction parameters, and/or other types of parameters. The one or more resource parameters may be configured to identify resources to be implemented to provide the cloud application functions. The resource parameters may include at least a model parameter and/or other types of resource parameters. Values of the model parameter may specify one or more machine learning models to be implemented to provide the cloud application function. The one or more models may be publicly available models (e.g., GPT-3, GPT-3.5, GPT-4, Claude-v1, Claude-v2, Claude Instant, etc.), private models, and/or other types of models. Publicly available models may be obtained from external resources 126 via network(s) 118 and/or other sources. Private models may be uploaded by developing users (e.g., via client computing platform(s) 104), obtained from electronic storage 128, and/or other sources.

In some implementations, the application function parameters may include one or more application function parameters that are subordinate to other ones of the one or more application function parameters. By way of non-limiting illustration, the application function parameters may include one or more application function parameters that are subordinate to the model parameter and/or other application function parameters. Values of the one or more subordinate application function parameters may be associated with and/or relevant to the values of the model parameter. In some implementations, values of the one or more application function parameters that are subordinate to the model parameter may modify, constrain, and/or otherwise impact the one or more machine learning models specified by values of the model parameter.

The resource parameters may include a database parameter and/or other types of resource parameters. Values of the database parameter may specify one or more databases and/or information sources that may be implemented to provide the cloud application functions. In some implementations, the resource parameters may include a function parameter. Values of the function parameter may specify one or more other cloud function applications that may be implemented and/or executed to provide the cloud function application.

Values of instructions parameters may define instructions for implementing the resources defined by the values of resource parameters. The instruction parameters may include a goal parameter and/or other types of instruction parameters. Values of the goal parameter specifying the goals, aims, and/or other purposes the resources are implemented to provide. The instruction parameters may include a prompt parameter and/or other types of instruction parameters. One or more values of the prompt parameter may specify how to configure resource-level prompts to the one or more models specified by the model parameter. Values of the prompt parameter may specify a prompt format, one or more fields for passing information to the one or more machine-learning models, context to be provided to the one or more machine-learning models, goals defining an action or operation the developer wants the one or more machine-learning models to achieve, and/or other information. In some implementations, the values of the prompt parameter may indicate the goals, aims, and/or other purposes specified by the values of the goal parameter for configuring the resource-level prompts. The instruction parameters may include an operation parameters and/or other types of instruction parameters. Values of the operation parameters may define one or more operations to be performed to implement the cloud application function. The one or more operations may be performed using outputs generated by the one or more machine-learning models specified by values of the model parameter.

Input component 114 may be configured to receive, from the client computing platforms 104, input information and/or other information. The input information may indicate the values of application function parameters by the developers via the application function development interface. By way of non-limiting illustration, first input information may be received from the first client computing platform. The first input information may include one or more values of the one or more instruction parameters, one or more values of the one or more resource parameters, and/or other values. The one or more values of the one or more resource parameters may include at least a first value of the model parameter specifying a first machine-learning model.

Function component 116 may be configured to, responsive to the receipt of the input information, configure function definitions of cloud application functions in accordance with the input information. Configuring the function definitions may include identifying function inputs, function outputs, environment variables, and/or other information. The function inputs, function outputs, environment variable, and/or other information may be based on the selected values of application function parameters included in the input information. Configuring the function definitions may include identifying the resources specified by the one or more values of the resource parameters include in the input information. In some implementations, configuring the function definition may include compiling an file in accordance with the input information and/or storing the file in electronic storage 128. The file may be a source code file, a deployment package, script file, a configuration file, and/or other types of files.

By way of non-limiting illustration, the function definitions may include a first function definition of a first cloud application function configured in accordance with first input information. The first function definition may identify lists of resources implemented to provide the first cloud application function. The resources may be specified by the one or more values of the one or more resource parameters. The resources may include the first machine-learning model. The first function definition may include instructions dictating how the first machine-learning model is implemented to provide the first cloud application function. The instructions may be specified by the one or more values of the one or more instructions parameters.

Function component 116 may be configured to provide the function definitions of the cloud application functions to the developers. The cloud application functions may be executed responsive to calls generated by applications specifying the cloud application functions. By way of non-limiting illustration, the first function definition of the first cloud application function may be provided such that the first cloud application function is executed responsive to a call generated by an application specifying the first cloud application function. In some implementations, providing the function definitions of the cloud application functions may include publishing the cloud application functions on a function marketplace. The function marketplace may facilitate access use of the cloud application functions by other developers. In some implementations, individual cloud application functions may be called by multiple different applications. The different applications may be associated with different developers.

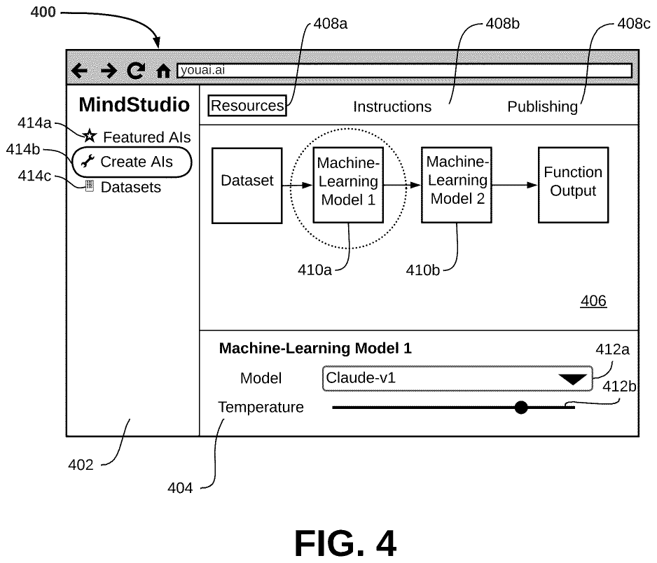

FIG. 4 illustrates a user interface 400 that may be used by a system to provide a user interface that facilitates development of customizable cloud functions. User interface 400 may illustrate an application function development interface including a first portion 402, a second portion 406, and/or other portions. The an application function development interface may be presented to a developer via a client computing platform associated with the developer. First portion 402 may include one or more interface elements 414a-c that are selectable by the user. Selection of individual ones of the interface elements 414a-c may facilitate modifications to displays in second portion 406. By way of non-limiting illustration, second portion 406 includes a display associated with an application function development of interface element 414b. Second portion 406 may display an application function development interface, responsive to selection of interface element 414b. The application function development interface may include one or more of a first interface element 408a, a second interface element 408b, a third interface element 408c, and/or other interface elements. The interface elements included in the application function development interface may be selectable by the user. Individual ones of the interface elements 408a-b included in the application function development interface may correspond to different types of application function parameters. By way of non-limiting illustration, first interface element 408a may effectuate a display to facilitate selection of one or more values of one or more resource parameters. Second interface element 408b may effectuate a display to facilitate selection of one or more values of instruction parameters. Responsive to selection of first interface element 408a, second portion may display one or more selection fields 412 a-b for selecting one or more resource parameters 410a-b. By way of non-limiting illustration, a first selection field 412 may facilitate selection of a value of a model parameter. The value of a model parameter may specify one or more models to be implemented to provide the cloud application function. Second selection field may facilitate selection of a values of a temperature parameter. Values of the temperature may dictate the randomness of outputs generated by the model specified by values of the model parameter. The temperature parameter may be subordinate to the model parameter.

In some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user corresponding to the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a Smartphone, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, and/or 116, and/or other components. Processor(s) 130 may be configured to execute components 108, 110, 112, 114, and/or 116, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and/or 116 are illustrated in FIG. 1 as being implemented within a single processing unit, in implementations in which processor(s) 130 includes multiple processing units, one or more of components 108, 110, 112, 114, and/or 116 may be implemented remotely from the other components. The description of the functionality provided by the different components 108, 110, 112, 114, and/or 116 described below is for illustrative purposes, and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, and/or 116. As another example, processor(s) 130 may be configured to execute one or more additional components that may perform some or all of the functionality attributed below to one of components 108, 110, 112, 114, and/or 116.

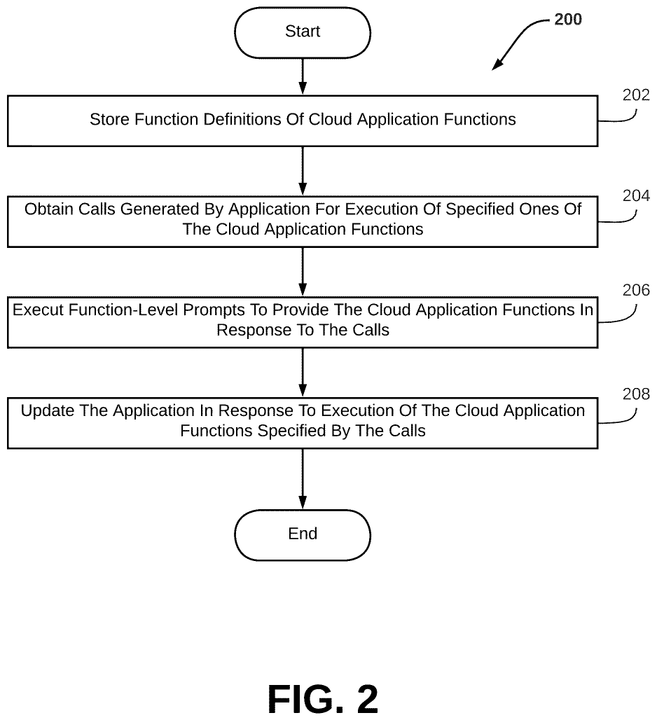

FIG. 2 illustrates a method 200 for providing customizable cloud application functions that implement machine-learning models to execute actions, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include storing function definitions of cloud application functions. The function definitions may identify lists of resources implemented to provide the cloud application functions. The function definitions may include instructions that facilitate the implementation of the cloud application functions by the resources. The resources may include one or more machine-learning models and/or other resources. By way of non-limiting illustration, the function definitions may include a first function definition of a first cloud application function and/or other function definitions. The first function definition may identify a first machine-learning model. The function definition may include instructions dictating how the first machine-learning model is implemented to provide the first cloud application function. Operation 202 may be performed by one or more hardware or software components that are the same as or similar to electronic storage 128, in accordance with one or more implementations.

An operation 204 may include obtaining calls generated by applications for execution of specified ones of the cloud application functions. The individual calls may specify one or more of the cloud applications functions to be executed. The individual calls may include one or more of function-level prompts, application information, and/or other information. The function-level prompts may facilitate implementation of the resources to provide the cloud application functions specified. The application information may be relevant to the function-level prompts. By way of non-limiting illustration, the calls may include a first call generated by a first application. The first call may specify the first application function. The first call may include a first function-level prompt that facilitates the implementation of the first machine-learning model to provide the first application function. The first call may include first application information relevant to the first function-level prompt and/or other information. Operation 204 may be performed by one or more hardware processors configured by machine-readable instructions including a component that is the same as or similar to call component 108, in accordance with one or more implementations.

An operation 206 may include executing the function-level prompts to provide the cloud application functions in response to the calls. Executing the function-level prompts may include configuring resource-level prompts in accordance with the application information for the resources identified by the function definitions of the cloud application functions to be provided. Executing the function-level prompts may further include prompting the resources with the resource-levels prompts to provide the cloud application functions. By way of non-limiting illustration, the first function-level prompt may be executed to provide the first cloud application function in response to the first call. Executing the first function-level prompt may include configuring a first resource-level prompt for the first machine-learning model in accordance with the first application information. Executing the first function-level prompt may further include prompting the first machine-learning model with the first resource-level prompt to execute the first cloud application function. Operation 206 may be performed by one or more hardware processors configured by machine-readable instructions including a component that is the same as or similar to execution component 110, in accordance with one or more implementations.

An operation 208 may include updating the applications in response to execution of the cloud application functions specified by the individual calls. By way of non-limiting illustration, the first application may be updated in response to execution of the first cloud application function. Operation 208 may be performed by one or more hardware processors configured by machine-readable instructions including a component that is the same as or similar to execution component 110, in accordance with one or more implementations.

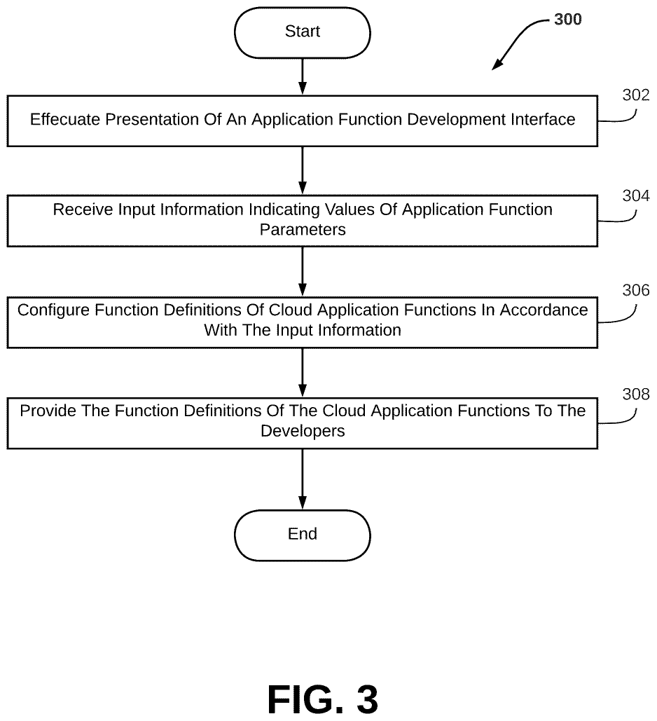

FIG. 3 illustrates a method 300 for providing a user interface that facilitates development of customizable cloud application functions, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include effectuating presentation of an application function development interface to developers through client computing platforms associated with the developers. The application function development interface may facilitate selection of values of application function parameters by the developers. The application function parameters may include one or more resource parameters, one or more instruction parameters, and/or other types of parameters. The one or more resource parameters may include at least a model parameter and/or other types of resource parameters. By way of non-limiting illustration, presentation of the application function development interface may be effectuated through a first client computing platform associated with a first developer. Operation 302 may be performed by one or more components that is the same as or similar to user interface component 112, in accordance with one or more implementations.

An operation 304 may include receiving, from the client computing platforms, input information and/or other information. The input information may indicate the values of application function parameters by the developers via the application function development interface. By way of non-limiting illustration, first input information may be received from the first client computing platform. The first input information may include one or more values of the one or more instruction parameters, one or more values of the one or more resource parameters, and/or other values. The one or more values of the one or more resource parameters may include at least a first value of the model parameter specifying a first machine-learning model. Operation 304 may be performed by one or more hardware processors configured by machine-readable instructions including a component that is the same as or similar to input component 114, in accordance with one or more implementations.

An operation 306 may include, responsive to the receipt of the input information, configuring function definitions of cloud application functions in accordance with the input information. By way of non-limiting illustration, the function definitions may include a first function definition of a first cloud application function configured in accordance with first input information. The first function definition may identify lists of resources implemented to provide the first cloud application function. The resources may be specified by the one or more values of the one or more resource parameters. The resources may include the first machine-learning model. The first function definition may include instructions dictating how the first machine-learning model is implemented to provide the first cloud application function. The instructions may be specified by the one or more values of the one or more instructions parameters. Operation 306 may be performed by one or more hardware processors configured by machine-readable instructions including a component that is the same as or similar to function component 116, in accordance with one or more implementations.

An operation 308 may include providing the function definitions of the cloud application functions to the developers. The cloud application functions may be executed responsive to calls generated by applications specifying the cloud application functions. By way of non-limiting illustration, the first function definition of the first cloud application function may be provided such that the first cloud application function is executed responsive to a call generated by an application specifying the first cloud application function. Operation 308 may be performed by one or more hardware processors configured by machine-readable instructions including a component that is the same as or similar to function component 116, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed:

1. A system configured to provide customizable cloud application functions, wherein the customizable cloud application functions implement machine-learning models to execute actions, the system comprising:
electronic storage that stores function definitions of cloud application functions, the function definitions identifying lists of resources implemented to provide the cloud application functions, and including instructions that facilitate the implementation of the cloud application functions by the resources, the resources including one or more machine-learning models, the function definitions including a first function definition of a first cloud application function, the first function definition identifying a first machine-learning model and instructions dictating how the first machine-learning model is implemented to provide the first cloud application function; and
one or more physical processors configured by machine-readable instructions to:
obtain calls generated by applications for execution of specified ones of the cloud application functions, wherein the individual calls specify one or more of the cloud applications functions to be executed, and wherein the individual calls include (i) function-level prompts which facilitate implementation of the resources to provide the cloud application functions specified and (ii) application information relevant to the function-level prompts, the calls including a first call generated by a first application, the first call specifying the first application function, the first call including a first function-level prompt that facilitates the implementation of the first machine-learning model to provide the first application function and first application information relevant to the first function-level prompt;
execute the function-level prompts to provide the cloud application functions in response to the calls, wherein executing the function-level prompts includes configuring resource-level prompts in accordance with the application information for the resources identified by the function definitions of the cloud application functions to be provided and prompting the resources with the resource-levels prompts to provide the cloud application functions, wherein the first function-level prompt is executed to provide the first cloud application function in response to the first call by:
configuring a first resource-level prompt for the first machine-learning model in accordance with the first application information; and
prompting the first machine-learning model with the first resource-level prompt to execute the first cloud application function;
update the applications in response to execution of the cloud application functions specified by the individual calls such that the first application is updated in response to execution of the first cloud application function.

2. The system of claim 1, wherein prompting the first machine-learning model with the first resource-level prompt includes:
providing the first application information as input to the first machine-learning model; and
obtaining outputs generated by the first machine-learning model based on the provided inputs.

3. The system of claim 2, wherein updating the first application includes providing the outputs generated by the first machine-learning model based on the first application information for use within the first application.

4. The system of claim 1, wherein the instructions included in the function definitions include instructions dictating how to configure the resource-level prompts for the resources.

5. The system of claim 1, wherein specifications for the applications include instructions dictating how to configure the function-level prompts to facilitate the implementation of the resources to provide the cloud application functions.

6. A system configured to provide a user interface that facilitates development of customizable cloud application functions, the system comprising:
one or more physical processors configured by machine-readable instructions to:
effectuate presentation of an application function development interface to developers through client computing platforms associated with the developers, the application function development interface facilitating selection of values of application function parameters by the developers, the application function parameters including one or more resource parameters and one or more instruction parameters, the one or more resource parameters including at least a model parameter, wherein presentation of the application function development interface is effectuated through a first client computing platform associated with a first developer;
receive, from the client computing platforms, input information indicating the values of application function parameters by the developers via the application function development interface, wherein first input information is received from the first client computing platform, the first input information including one or more values of the one or more instruction parameters and one or more values of the one or more resource parameters including at least a first value of the model parameter, the first value specifying a first machine-learning model;
responsive to the receipt of the input information, configure function definitions of cloud application functions in accordance with the input information, wherein the function definitions include a first function definition of a first cloud application function configured in accordance with first input information, the first function definition identifying lists of resources implemented to provide the first cloud application function, the resources being specified by the one or more values of the one or more resource parameters, the resources including the first machine-learning model, the first function definition including instructions dictating how the first machine-learning model is implemented to provide the first cloud application function, the instructions being specified by the one or more values of the one or more instructions parameters; and
provide the function definitions of the cloud application functions to the developers, wherein the cloud application functions are executed responsive to calls generated by applications specifying the cloud application functions, the first function definition of the first cloud application function being provided such that the first cloud application function is executed responsive to a call generated by an application specifying the first cloud application function.

7. The system of claim 6, wherein the instruction parameters include a prompt parameter, values of the prompt parameter specifying how to configure resource-level prompts to models specified by the model parameter.

8. The system of claim 6, wherein the generated calls specify one or more of the cloud application functions to be executed and include function-level prompts which facilitate implementation of the resources to provide the cloud application functions specified.

9. The system of claim 8, wherein specifications for the applications include instructions dictating how to configure function-level prompts included in the calls generated by the application.

10. The system of claim 6, wherein the values of the model parameter specify multiple models that function cooperatively to provide the cloud application functions.

11. A method for providing customizable cloud application functions, wherein the customizable cloud application functions implement machine-learning models to execute actions, the method comprising:
storing function definitions of cloud application functions, the function definitions identifying lists of resources implemented to provide the cloud application functions, and including instructions that facilitate the implementation of the cloud application functions by the resources, the resources including one or more machine-learning models, the function definitions including a first function definition of a first cloud application function, the first function definition identifying a first machine-learning model and instructions dictating how the first machine-learning model is implemented to provide the first cloud application function; and
obtaining calls generated by applications for execution of specified ones of the cloud application functions, wherein the individual calls specify one or more of the cloud applications functions to be executed, and wherein the individual calls include (i) function-level prompts which facilitate implementation of the resources to provide the cloud application functions specified and (ii) application information relevant to the function-level prompts, the calls including a first call generated by a first application, the first call specifying the first application function, the first call including a first function-level prompt that facilitates the implementation of the first machine-learning model to provide the first application function and first application information relevant to the first function-level prompt;
executing the function-level prompts to provide the cloud application functions in response to the calls, wherein executing the function-level prompts includes configuring resource-level prompts in accordance with the application information for the resources identified by the function definitions of the cloud application functions to be provided and prompting the resources with the resource-levels prompts to provide the cloud application functions, wherein the first function-level prompt is executed to provide the first cloud application function in response to the first call by:
configuring a first resource-level prompt for the first machine-learning model in accordance with the first application information; and
prompting the first machine-learning model with the first resource-level prompt to execute the first cloud application function;
updating the applications in response to execution of the cloud application functions specified by the individual calls such that the first application is updated in response to execution of the first cloud application function.

12. The method of claim 11, wherein prompting the first machine-learning model with the first resource-level prompt includes:
providing the first application information as input to the first machine-learning model; and
obtaining outputs generated by the first machine-learning model based on the provided inputs.

13. The method of claim 12, wherein updating the first application includes providing the outputs generated by the first machine-learning model based on the first application information for use within the first application.

14. The method of claim 11, wherein the instructions included in the function definitions include instructions dictating how to configure the resource-level prompts for the resources.

15. The method of claim 11, wherein specifications for the applications include instructions dictating how to configure the function-level prompts to facilitate the implementation of the resources to provide the cloud application functions.

16. A method for providing a user interface that facilitates development of customizable cloud application functions, the system comprising:
effectuating presentation of an application function development interface to developers through client computing platforms associated with the developers, the application function development interface facilitating selection of values of application function parameters by the developers, the application function parameters including one or more resource parameters and one or more instruction parameters, the one or more resource parameters including at least a model parameter, including effectuating presentation of the application function development interface through a first client computing platform associated with a first developer;
receiving, from the client computing platforms, input information indicating the values of application function parameters by the developers via the application function development interface, including receiving first input information from the first client computing platform, the first input information including one or more values of the one or more instruction parameters and one or more values of the one or more resource parameters including at least a first value of the model parameter, the first value specifying a first machine-learning model;
responsive to the receipt of the input information, configuring function definitions of cloud application functions in accordance with the input information, including configuring a first function definition of a first cloud application function in accordance with first input information, the first function definition identifying lists of resources implemented to provide the first cloud application function, the resources being specified by the one or more values of the one or more resource parameters, the resources including the first machine-learning model, the first function definition including instructions dictating how the first machine-learning model is implemented to provide the first cloud application function, the instructions being specified by the one or more values of the one or more instructions parameters; and
providing the function definitions of the cloud application functions to the developers, wherein the cloud application functions are executed responsive to calls generated by applications specifying the cloud application functions, including providing the first function definition of the first cloud application function such that the first cloud application function is executed responsive to a call generated by an application specifying the first cloud application function.

17. The method of claim 16, wherein the instruction parameters include a prompt parameter, values of the prompt parameter specifying how to configure resource-level prompts to models specified by the model parameter.

18. The method of claim 16, wherein the generated calls specify one or more of the cloud application functions to be executed and include function-level prompts which facilitate implementation of the resources to provide the cloud application functions specified.

19. The method of claim 18, wherein specifications for the applications include instructions dictating how to configure function-level prompts included in the calls generated by the application.

20. The method of claim 16, wherein the values of the model parameter specify multiple models that function cooperatively to provide the cloud application functions.
